(19) United States
(12) Patent Application Publication
(10) Pub. No.: US 2022/0167467 A1
(43) Pub. Date: May 26, 2022

(54) ELECTROMAGNETIC WAVE TRANSMITTING HEATER

(71) Applicant: TOYOTA JIDOSHA KABUSHIKI KAISHA, Toyota-shi (JP)

(72) Inventors: Keigo INABA, Toyota-shi (JP); Akira Kato, Toyota-shi (JP); Daiki Kuboyama, Toyota-shi (JP); Rika Hatano, Toyota-shi (JP); Soma Higashikozono, Toyota-shi (JP)

(73) Assignee: TOYOTA JIDOSHA KABUSHIKI KAISHA, Toyota-shi (JP)

(21) Appl. No.: 17/523,429

(22) Filed: Nov. 10, 2021

(30) Foreign Application Priority Data
Nov. 24, 2020 (JP) 2020-194546

(51) Int. Cl. H05B 3/84; H05B 3/26

(52) U.S. Cl. CPC H05B 3/84; G01S 7/03; H05B 2203/011; H05B 3/26

(57) ABSTRACT

Provided is an electromagnetic wave transmitting heater that has excellent heating properties and is capable of suppressing an increase in a cross section of a heater wire. The electromagnetic wave transmitting heater includes a plurality of heater wires disposed at intervals to allow transmission of electromagnetic waves, a pair of lateral wires, one of the pair of lateral wires being coupled to one end of each of the heater wires, another one of the pair of lateral wires being coupled to another end of each of the heater wires, and a pair of coupling wires, one of the pair of coupling wires being coupled to one of the pair of lateral wires, another one of the pair of coupling wires being coupled to another one of the pair of lateral wires. The lateral wires each have a cross section larger than a cross section of each of the heater wires.

### CROSS REFERENCE TO RELATED APPLICATIONS

The present application claims priority from Japanese patent application JP 2020-194546 filed on Nov. 24, 2020, the entire content of which is hereby incorporated by reference into this application.

### BACKGROUND

### Technical Field

The present disclosure relates to an electromagnetic wave transmitting heater.

### Background Art

There is known a conventional electromagnetic wave transmitting cover that is installed in the electromagnetic wave irradiation direction of a sensor using electromagnetic waves, and a method for manufacturing the electromagnetic wave transmitting cover (see JP 2020-005057 A). The electromagnetic wave transmitting cover described in JP 2020-005057 A includes a colored resin member, a transparent resin member, and a transparent heater film. The transparent resin member is provided on one side of the colored resin member opposite to the sensor. The transparent heater film is provided on one side of the colored resin member opposite to the sensor, has a wiring pattern formed by copper plating or etching, and has electromagnetic wave transmission properties (Abstract of JP 2020-005057 A, for example).

The wiring pattern includes a heater section and a wire extending from the heater section. The heater section includes four systems connected in parallel. Specifically, the heater section has a pattern that obliquely intersects a short-length direction. However, the pattern of the heater section may be any one of the vertical direction, the horizontal direction, or the oblique direction (paragraph 0021, FIG. 4 of JP 2020-005057 A, for example).

### SUMMARY

The transparent heater film of the conventional electromagnetic wave transmitting cover includes the heater section with four systems connected in parallel. However, with such a small number of systems of the heater section, the wire of the heater section of the transparent heater film needs to be meandered and thus requires a large length in order to cover the entire area requiring heating (JP 2020-005057 A, FIG. 4).

However, as the length of the wire of the heater section increases, the wire has a higher electrical resistance and the heater section may not have required heating properties. Thus, in order to increase the heating properties of the heater section, the wire of the heater section needs to have a larger cross section to suppress an increase in the electrical resistance of the wire. However, if the wire of the heater section has a larger cross section, the wire may become easily visually recognizable. This may impair the designability of the electromagnetic wave transmitting cover that is used as an emblem attached to a vehicle, for example.

The present disclosure provides an electromagnetic wave transmitting heater that has excellent heating properties and is capable of suppressing an increase in the cross section of a heater wire.

According to one aspect of the present disclosure, there is provided an electromagnetic wave transmitting heater including: a plurality of heater wires disposed at intervals to allow transmission of electromagnetic waves; a pair of lateral wires, one of the pair of lateral wires being coupled to one end of each of the heater wires, another one of the pair of lateral wires being coupled to another end of each of the heater wires; and a pair of coupling wires, one of the pair of coupling wires being coupled to one of the pair of lateral wires, another one of the pair of coupling wires being coupled to another one of the pair of lateral wires, wherein the lateral wires each have a cross section larger than a cross section of each of the heater wires.

In some embodiments of the electromagnetic wave transmitting heater, the pair of lateral wires is axisymmetric with respect to a center line intersecting the pair of lateral wires, as a distance from the center line along the lateral wire increases, a distance between the pair of lateral wires decreases and a length of the heater wire decreases, and one of the coupling wires is coupled to one of the lateral wires at a plurality of coupling points that is axisymmetric with respect to the center line and another one of the coupling wires is coupled to another one of the lateral wires at a plurality of coupling points that is axisymmetric with respect to the center line.

In some embodiments of the electromagnetic wave transmitting heater, the plurality of heater wires is parallel to the center line.

In some embodiments of the electromagnetic wave transmitting heater, a distance between the pair of lateral wires is smaller than a distance between one end and another end of each of the pair of lateral wires.

In some embodiments of the electromagnetic wave transmitting heater, the pair of lateral wires has an outwardly projecting curved shape with a vertex, the vertex being an intersection with the center line.

In some embodiments of the electromagnetic wave transmitting heater, when X is a ratio of a length of the lateral wire from the center line to the coupling point to a length of the lateral wire from the center line to one end of the lateral wire, and Y is a ratio of a cross section of the lateral wire to a cross section of the heater wire, the electromagnetic wave transmitting heater satisfies the following expression (1):

(X−0.28)²/0.28²+(Y−11.6)²/3.4²≤1 (1).

In some embodiments of the electromagnetic wave transmitting heater, among the plurality of heater wires, a heating amount of the heater wire having a largest heating amount is smaller than or equal to double a heating amount of the heater wire having a smallest heating amount.

According to the above aspect of the present disclosure, it is possible to provide an electromagnetic wave transmitting heater that has excellent heating properties and is capable of suppressing an increase in the cross section of the heater wire.

### BRIEF DESCRIPTION OF THE DRAWINGS

FIG. 1 is a perspective view of a vehicle, showing an embodiment of an electromagnetic wave transmitting heater of the present disclosure;

FIG. 2 is a schematic enlarged cross-sectional view of an electromagnetic wave transmitting cover attached to the vehicle of FIG. 1;

FIG. 3 is a plan view of the electromagnetic wave transmitting heater included in the electromagnetic wave transmitting cover of FIG. 2;

FIG. 4 is a graph showing the heating properties of the electromagnetic wave transmitting heater of FIG. 3;

FIG. 5 is a graph showing the relation among X that expresses a ratio of the lengths of a lateral wire, Y that expresses a ratio of the cross section of a lateral wire to the cross section of a heater wire, and a difference ΔQ in heating amount in the electromagnetic wave transmitting heater of FIG. 3;

FIG. 6 is a plan view of a modification of the electromagnetic wave transmitting heater of FIG. 3; and

FIG. 7 is a graph showing the heating properties of the electromagnetic wave transmitting heater of FIG. 6.

### DETAILED DESCRIPTION

Hereinafter, an embodiment of the electromagnetic wave transmitting heater according to the present disclosure will be described with reference to the drawings.

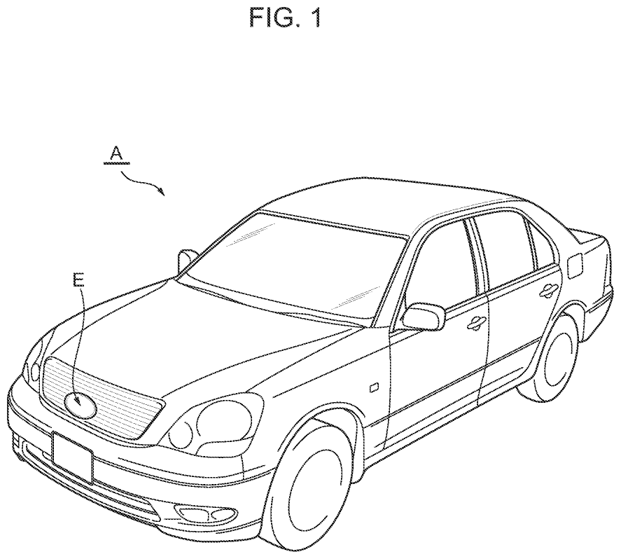

FIG. 1 is a perspective view of a vehicle A, showing an embodiment of the electromagnetic wave transmitting heater of the present disclosure. The vehicle A has an emblem E attached at the center of its front end in the vehicle width direction, for example. The vehicle A has a millimeter-wave radar sensor (not illustrated) embedded on the rear side of the emblem E, for example. The emblem E allows transmission of millimeter waves as transmission waves that are emitted from the millimeter-wave radar sensor to the front of the vehicle A, and also allows transmission of millimeter waves as reflected waves that are reflected from an obstacle ahead of the vehicle A and allows the millimeter-wave radar sensor to receive them.

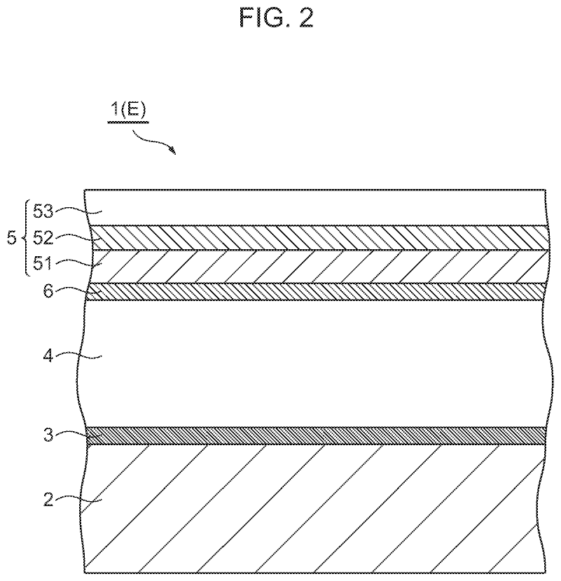

FIG. 2 is a schematic enlarged cross-sectional view of a part of an electromagnetic wave transmitting cover 1. The electromagnetic wave transmitting cover 1 is used as the emblem E attached to the vehicle A illustrated in FIG. 1 and allows transmission of millimeter waves emitted from the millimeter-wave radar sensor, for example. The electromagnetic wave transmitting cover 1 has a shape corresponding to the emblem E of the vehicle A, for example. The electromagnetic wave transmitting cover 1 includes a colored layer 2, a design layer 3, a transparent resin layer 4, and a transparent film heater 5, for example.

In the example illustrated in FIG. 1, the emblem E has an oval or elliptic shape when viewed from the front. Thus, the electromagnetic wave transmitting cover 1 illustrated in FIG. 2 also has an oval or elliptic shape when viewed from the front, for example. It should be noted that the shape of the electromagnetic wave transmitting cover 1 is not particularly limited, and may be a circle, triangle, rectangle, any other polygon, or any other shape, for example. Furthermore, the relation among the thicknesses of the layers and the configuration of the layers illustrated in FIG. 2 are one example, and may not correspond to an actual relation among the thicknesses of the layers and an actual configuration of the layers.

The colored layer 2 is a black-colored resin layer, for example, and has projections and recesses according to the design of the emblem E. The design layer 3 is stacked on the colored layer 2 and has a design such as a metallic pattern, for example. Though not illustrated in the drawings, the design layer 3 has a plurality of layers including a resin base, a deposited layer such as indium formed on the surface of the base, and a transparent protective layer coating the deposited layer, for example.

The transparent resin layer 4 is a colorless transparent resin layer that is formed into a shape corresponding to the front shape of the electromagnetic wave transmitting cover 1 and is laminated on the design layer 3, for example. The transparent film heater 5 is a heater formed into a transparent thin film having visible light transmission properties and electromagnetic wave transmission properties, for example. The transparent film heater 5 is laminated on the transparent resin layer 4 with an adhesive layer 6 interposed therebetween, for example. The transparent film heater 5 is disposed opposite to the colored layer 2, which is disposed to face the millimeter-wave radar sensor inside of the vehicle A, and is exposed outside of the vehicle A.

The transparent film heater 5 has a planform corresponding to the front shape of the emblem E, that is, the front shape of the electromagnetic wave transmitting cover 1, such as an oval or elliptic shape, for example. The transparent film heater 5 is adapted to maintain the temperature of the surface of the electromagnetic wave transmitting cover 1 within the range of 0° C. to 40° C. inclusive, for example, so as to melt snow and ice on the surface of the electromagnetic wave transmitting cover 1. The transparent film heater 5 includes a transparent resin base 51, an electromagnetic wave transmitting heater 52 formed on the base 51, and a transparent protective layer 53 coating the electromagnetic wave transmitting heater 52, for example.

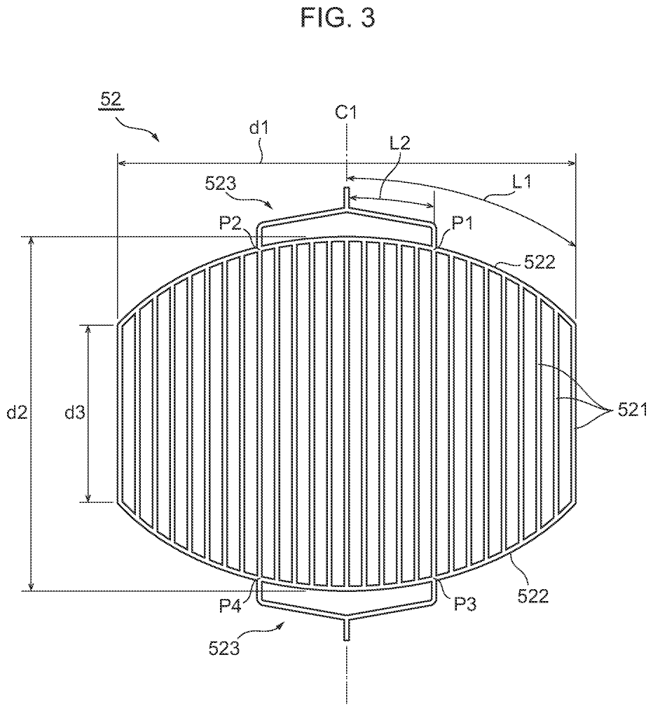

FIG. 3 is a schematic plan view of the electromagnetic wave transmitting heater 52 illustrated in FIG. 2. In a state where the electromagnetic wave transmitting cover 1 is attached to the vehicle A as the emblem E, the perpendicular direction, that is, the top-bottom direction, of the electromagnetic wave transmitting heater 52 in FIG. 3 is a direction along the vertical direction or a direction parallel to the vertical direction. It should be noted that the electromagnetic wave transmitting cover 1 may also be rotated by an appropriate angle and then attached to the vehicle A. Thus, the perpendicular direction of the electromagnetic wave transmitting heater 52 in FIG. 3 is not limited to the vertical direction or a direction along the vertical direction, and may be the horizontal direction or a direction along the horizontal direction, for example.

As illustrated in FIG. 3, the electromagnetic wave transmitting heater 52 includes a plurality of heater wires 521, a pair of lateral wires 522, and a pair of coupling wires 523. Examples of the material of the wire of the electromagnetic wave transmitting heater 52 may include a metal material with a low electrical resistance, such as copper, silver, an alloy thereof, for example. The wire of the electromagnetic wave transmitting heater 52 may be formed through screen printing, for example.

Using the above-mentioned metal material with a low electrical resistance as the material of the wire of the electromagnetic wave transmitting heater 52 can increase the heating amount of the electromagnetic wave transmitting heater 52. In addition, since it is possible to suppress an increase in the cross sections of the heater wire 521, the lateral wire 522, and the coupling wire 523, the wires of the transparent film heater 5 can be less visually recognizable and the electromagnetic wave transmitting cover 1 can have an improved designability.

In addition, in view of ensuring required electromagnetic wave transmission properties, the width of each wire of the electromagnetic wave transmitting heater 52 may be set to smaller than or equal to 400 μm, for example. Further, the thickness of each wire of the electromagnetic wave transmitting heater 52, which may be formed through printing, may be set to about 10 μm at maximum, for example. In view of ensuring excellent electromagnetic wave transmission properties and excellent heating properties, the cross section of each wire of the electromagnetic wave transmitting heater 52 may be set to larger than or equal to 200 μm² and smaller than or equal to 4000 μm², for example.

The plurality of heater wires 521 is disposed at intervals to allow transmission of electromagnetic waves. Specifically, the plurality of heater wires 521 is disposed at intervals to allow transmission of millimeter waves emitted from the millimeter-wave radar sensor, for example. More specifically, when the adjacent heater wires 521 are arranged with an interval of 4 mm or larger, for example, the plurality of heater wires 521 can allow transmission of millimeter waves emitted from the millimeter-wave radar sensor.

In addition, in view of ensuring heating properties required for the electromagnetic wave transmitting heater 52, the interval between the adjacent heater wires 521 may be set to 10 mm or smaller, for example. In the example illustrated in FIG. 3, a pitch between the plurality of heater wires 521 is set to 5 mm, and all of the adjacent heater wires 521 are disposed at substantially equal intervals of 4 mm or larger. Furthermore, in the example illustrated in FIG. 3, the plurality of heater wires 521 is aligned in the lateral direction.

In the lateral direction illustrated in FIG. 3, a distance d1 between the heater wire 521 at one end and the heater wire 521 at the other end among the plurality of heater wires 521, that is, a distance d1 between one end and the other end of the lateral wire 522, is set to 130 mm, for example. Thus, the electromagnetic wave transmitting heater 52 illustrated in FIG. 3 has 27 heater wires 521, for example. It should be noted that this number of heater wires 521 is one example, and the number of heater wires 521 may vary depending on the dimensions of the transparent film heater 5 and the electromagnetic wave transmitting cover 1.

One of the pair of lateral wires 522 is coupled to one end of each of the heater wires 521 and the other one of the pair of lateral wires 522 is coupled to the other end of each of the heater wires 521. More specifically, in the example illustrated in FIG. 3, the pair of the lateral wires 522 extends in the lateral direction, and is disposed with a distance therebetween in the perpendicular direction. The upper end of each of the heater wires 521 is coupled to the upper lateral wire 522, which is one of the pair of lateral wires 522. Meanwhile, the lower end of each of the heater wires 521 is coupled to the lower lateral wire 522, which is the other one of the pair of lateral wires 522.

The lateral wires 522 each have a cross section larger than the cross section of each of the heater wires 521. When the cross section of the heater wire 521 is expressed as S1 and the cross section of the lateral wire 522 is expressed as S2, for example, S1:S2, that is, a ratio of the cross section S1 of the heater wire 521 to the cross section S2 of the lateral wire 522, is 1:11.6, for example. It should be noted that S1:S2, that is, a ratio of the cross section S1 of the heater wire 521 to the cross section S2 of the lateral wire 522, may appropriately be changed, which will be described later.

In addition, as illustrated in FIG. 3, for example, the pair of lateral wires 522 is axisymmetric with respect to the center line C1 of the electromagnetic wave transmitting heater 52, which intersects the pair of lateral wires 522. The plurality of heater wires 521 is parallel to the center line C1 and extends in one direction parallel to the center line C1, for example. It should be noted that the heater wire 521 may not necessarily be parallel to the center line C1, and may extend in one direction intersecting the center line C1, for example.

In addition, the distance between the pair of lateral wires 522 is smaller than the distance d1 between one end and the other end of each of the pair of lateral wires 522, for example. More specifically, in the example illustrated in FIG. 3, the pair of lateral wires 522 is disposed with a distance therebetween in the perpendicular direction, and extends in the lateral direction. A dimension d2 between the upper end of the upper lateral wire 522, which is one of the pair of lateral wires 522, and the lower end of the lower lateral wire 522, which is the other one of the pair of lateral wires 522, is smaller than the distance d1 between one end and the other end of each of the lateral wires 522 in the lateral direction. In other words, the electromagnetic wave transmitting heater 52 has a widthwise direction (i.e., the perpendicular direction in FIG. 3) and a lengthwise direction (i.e., the lateral direction in FIG. 3), for example. In the portion of the electromagnetic wave transmitting heater 52 except the pair of coupling wires 523, the dimension d2 in the widthwise direction is smaller than the dimension d1 in the lengthwise direction.

In addition, the pair of lateral wires 522 has an outwardly projecting curved shape with a vertex that is the intersection with the center line C1, for example. More specifically, the pair of lateral wires 522 has a curved shape of an arc shape, oval arc shape, or quadratic curve shape that is axisymmetric with respect to the center line C1, for example. Thus, in the example illustrated in FIG. 3, the electromagnetic wave transmitting heater 52 has a shape such that the shape of the portion except the pair of coupling wires 523 corresponds to the oval or elliptic shape of the emblem E illustrated in FIG. 1.

In addition, in the electromagnetic wave transmitting heater 52, as a distance from the center line C1 along the lateral wire 522 increases, the distance between the pair of lateral wires 522 decreases and the length of the heater wire 521 decreases, for example. In the example illustrated in FIG. 3, the electromagnetic wave transmitting heater 52 has a shape corresponding to the oval or elliptic shape, so that as a distance from the center line C1 along the lateral wire 522 increases, the distance between the pair of lateral wires 522 decreases and the length of the heater wire 521 decreases. It should be noted that also when the electromagnetic wave transmitting heater 52 has a shape corresponding to a circle or when the electromagnetic wave transmitting heater 52 has a shape of a rhombus or a hexagon, as a distance from the center line C1 along the lateral wire 522 increases, the distance between the pair of lateral wires 522 decreases and the length of the heater wire 521 decreases.

One of the pair of coupling wires 523 is coupled to one of the pair of lateral wires 522 and the other one of the pair of coupling wires 523 is coupled to the other one of the pair of lateral wires 522. More specifically, in the example illustrated in FIG. 3, the pair of coupling wires 523 is disposed with a distance therebetween in the perpendicular direction or the top-bottom direction. The upper coupling wire 523, which is one of the pair of coupling wires 523, is coupled to the upper lateral wire 522, which is one of the pair of lateral wires 522. Meanwhile, the lower coupling wire 523, which is the other one of the pair of coupling wires 523, is coupled to the lower lateral wire 522, which is the other one of the pair of lateral wires 522.

The electromagnetic wave transmitting heater 52 generates heat with power supplied via the pair of coupling wires 523. That is, one of the pair of coupling wires 523 serves as a coupling wire 523 on the input side, and the other one of the pair of coupling wires 523 serves as a coupling wire 523 on the output side. Current supplied from the coupling wire 523 on the input side flows through the plurality of heater wires 521 via the lateral wire 522 on the input side coupled to the coupling wire 523 on the input side, and further flows to the coupling wire 523 on the output side via the lateral wire 522 on the output side opposite to the lateral wire 522 on the input side.

One of the coupling wires 523 is coupled to one of the lateral wires 522 at a plurality of coupling points P1, P2, which is axisymmetric with respect to the center line C1, and the other one of the coupling wires 523 is coupled to the other one of the lateral wires 522 at a plurality of coupling points P3, P4, which is axisymmetric with respect to the center line C1, for example. In the example illustrated in FIG. 3, each of the ends of the pair of coupling wires 523 coupled to the lateral wires 522 is branched into two. The upper coupling wire 523, which is one of the pair of coupling wires 523, is coupled to the upper lateral wire 522, which is one of the pair of lateral wires 522, at the two coupling points P1, P2. Meanwhile, the lower coupling wire 523, which is the other one of the pair of coupling wires 523, is coupled to the lower lateral wire 522, which is the other one of the pair of lateral wires 522, at the two coupling points P3, P4.

In addition, in the electromagnetic wave transmitting heater 52, among the plurality of heater wires 521, the heating amount of the heater wire 521 having a largest heating amount is smaller than or equal to double the heating amount of the heater wire 521 having a smallest heating amount. More specifically, in the electromagnetic wave transmitting heater 52 illustrated in FIG. 3, L2/L1, that is, a ratio of the length L2 of the lateral wire 522 from the center line C1 to the coupling point P1 to the length L1 of the lateral wire 522 from the center line C1 to one end of the lateral wire 522, is expressed as X. Meanwhile, S2/S1, that is, a ratio of the cross section S2 of the lateral wire 522 to the cross section S1 of the heater wire 521, is expressed as Y. In this case, the electromagnetic wave transmitting heater 52 satisfies, for example, the following expression (1):

(X−0.28)²/0.28²+(Y−11.6)²/3.4²≤1 (1).

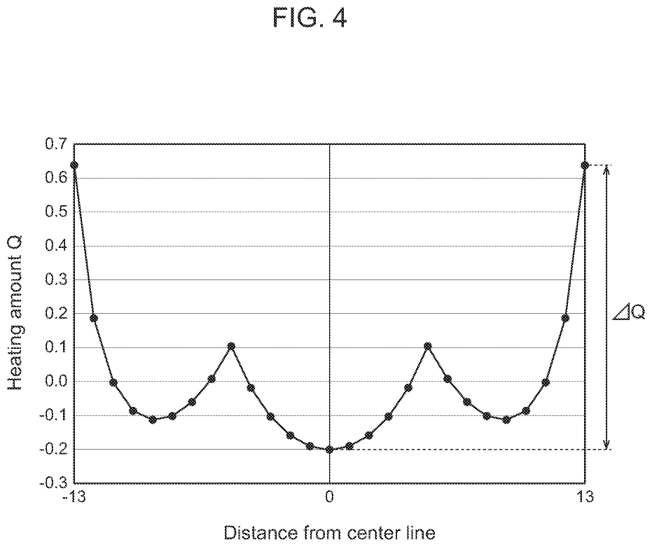

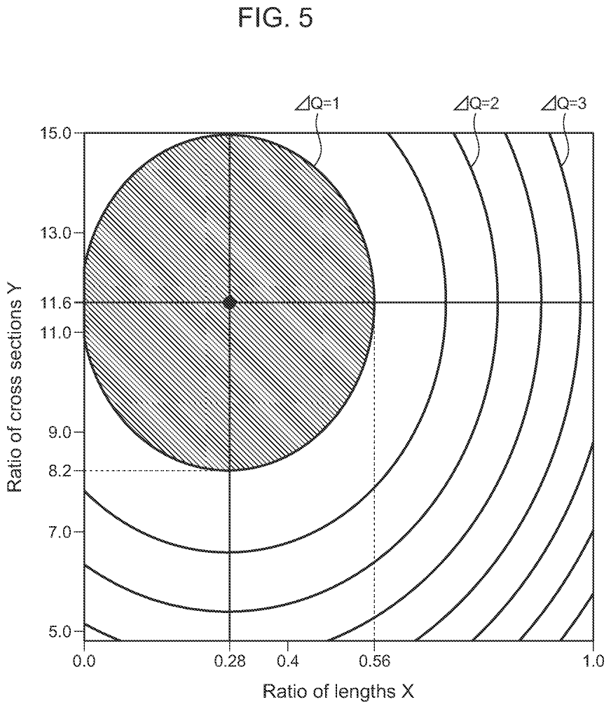

Hereinafter, the functions of the electromagnetic wave transmitting heater 52, the transparent film heater 5, and the electromagnetic wave transmitting cover 1 of the present embodiment will be described with reference to FIG. 4 and FIG. 5. FIG. 4 is a graph showing the heating properties of the electromagnetic wave transmitting heater 52 of FIG. 3. FIG. 5 is a graph showing the relation among X that expresses a ratio of the lengths of the lateral wire 522, Y that expresses a ratio of the cross sections, and the difference ΔQ in heating amount in the electromagnetic wave transmitting heater 52 of FIG. 3.

In the graph of FIG. 4, the horizontal axis shows a distance from the center line C1 of the electromagnetic wave transmitting heater 52 to each of the heater wires 521 as a unit of pitch of the heater wires 521. That is, the heater wire 521 at the center illustrated in FIG. 3 has a distance of 0 from the center line C1. Meanwhile, the thirteenth heater wire 521 as counted from the heater wire 521 at the center to the right has a distance of 13 from the center line C1. The thirteenth heater wire 521 as counted from the heater wire 521 at the center to the left has a distance of −13 from the center line C1.

In addition, in the graph of FIG. 4, the vertical axis shows a heating amount Q, in which the average of the heating amounts of the heater wires 521 is set to 0. It should be noted that in the graph of FIG. 4, when the difference ΔQ in heating amount between the heater wire 521 having a largest heating amount and the heater wire 521 having a smallest heating amount is set to 1, the heating amount of the heater wire 521 having a largest heating amount is double the heating amount of the heater wire 521 having a smallest heating amount.

As described above, the electromagnetic wave transmitting heater 52 of the present embodiment includes the plurality of heater wires 521, the pair of lateral wires 522, and the pair of coupling wires 523. The plurality of heater wires 521 is disposed at intervals to allow transmission of electromagnetic waves. One of the pair of lateral wires 522 is coupled to one end of each of the heater wires 521 and the other one of the pair of lateral wires 522 is coupled to the other end of each of the heater wires 521. One of the pair of coupling wires 523 is coupled to one of the pair of lateral wires 522 and the other one of the pair of coupling wires 523 is coupled to the other one of the pair of lateral wires 522. The lateral wires 522 each have a cross section larger than the cross section of each of the heater wires 521.

With such a configuration, the electromagnetic wave transmitting heater 52 of the present embodiment can increase the number of heater wires 521 disposed between the pair of lateral wires 522 and can reduce the length of each heater wire 521 according to the dimension of the electromagnetic wave transmitting heater 52. Thus, the electromagnetic wave transmitting heater 52 of the present embodiment can suppress an increase in the electrical resistance of each heater wire 521 and can reduce the cross section of each heater wire 521. Therefore, the heater wires 521 can be less easily visually recognizable, and the electromagnetic wave transmitting cover 1 including the electromagnetic wave transmitting heater 52 can have an improved designability.

In addition, as described above, the lateral wires 522 each have a cross section larger than the cross section of each of the heater wires 521. Thus, the electrical resistance of each lateral wire 522 per unit length can be lower than the electrical resistance of each heater wire 521 per unit length. This can supply current more uniformly to each of the heater wires 521 coupled to the lateral wires 522 via the lateral wires 522, and can increase the heating properties of the electromagnetic wave transmitting heater 52. As described above, according to the electromagnetic wave transmitting heater 52 of the present embodiment, it is possible to increase the heating properties of the electromagnetic wave transmitting heater 52 and suppress an increase in the cross section of the heater wire 521, and the electromagnetic wave transmitting cover 1 can have an improved designability.

In addition, in the electromagnetic wave transmitting heater 52 of the present embodiment, the pair of lateral wires 522 is axisymmetric with respect to the center line C1 intersecting the pair of lateral wires 522. In addition, as a distance from the center line C1 along the lateral wire 522 increases, the distance between the pair of lateral wires 522 decreases and the length of the heater wire 521 decreases. One of the coupling wires 523 is coupled to one of the lateral wires 522 at the plurality of coupling points P1, P2, which is axisymmetric with respect to the center line C1, and the other one of the coupling wires 523 is coupled to the other one of the lateral wires 522 at the plurality of coupling points P3, P4, which is axisymmetric with respect to the center line C1.

When the distance between the pair of lateral wires 522 changes and the lengths the plurality of heater wires 521 are uneven as described above, the electrical resistances of the heater wires 521 become uneven. Specifically, the heater wire 521 coupled to the lateral wire 522 with a larger distance from the center line C1 tends to have a smaller length and a lower electrical resistance and have a larger heating amount with more current flowing therethrough. More specifically, as illustrated in FIG. 3 and FIG. 4, for example, among the plurality of heater wires 521, the heater wire 521 having the largest length on the center line C1 has the smallest heating amount, whereas the heater wires 521 having the smallest length coupled to the opposite ends of the lateral wires 522, that is, the furthest heater wires 521 from the center line C1, have the largest heating amount.

However, in the electromagnetic wave transmitting heater 52 of the present embodiment, one of the coupling wires 523 is coupled to one of the lateral wires 522 at the plurality of coupling points P1, P2, which is axisymmetric with respect to the center line C1, and the other one of the coupling wires 523 is coupled to the other one of the lateral wires 522 at the plurality of coupling points P3, P4, which is axisymmetric with respect to the center line C1, as described above. This can supply current more uniformly to the plurality of heater wires 521. More specifically, as illustrated in FIG. 3, for example, the coupling points P1, P2 of one of the coupling wires 523 are located at the ends of the fifth heater wires 521 as counted from the heater wire 521 on the center line C1 to the right and to the left, respectively, and the coupling points P3, P4 of the other one of the coupling wires 523 are located at the ends of the fifth heater wires 521 as counted from the heater wire 521 on the center line C1 to the right and to the left, respectively. As a result, as illustrated in FIG. 4, it is possible to increase the heating amounts Q of the fifth heater wires 521 as counted from the heater wire 521 on the center line C1 to the right and to the left and the heating amounts Q of the heater wires 521 in the vicinity of these fifth heater wires 521.

Accordingly, as illustrated in FIG. 4, the difference ΔQ in heating amount Q between the heater wire 521 having a largest heating amount and the heater wire 521 having a smallest heating amount can be smaller than or equal to 1, and the largest heating amount of each heater wire 521 can be smaller than or equal to double the smallest heating amount of each heater wire 521. As a result, the electromagnetic wave transmitting heater 52 can maintain the temperature of the surface of the electromagnetic wave transmitting cover 1, that is, the surface of the transparent film heater 5, within the range of 0° C. to 40° C. inclusive, which is suitable for melting snow and ice and will not adversely affect the resin forming the electromagnetic wave transmitting cover 1 and the transparent film heater 5. Thus, according to the electromagnetic wave transmitting heater 52 of the present embodiment, it is possible to increase the heating properties of the electromagnetic wave transmitting heater 52.

In addition, in the electromagnetic wave transmitting heater 52 of the present embodiment, the plurality of heater wires 521 is parallel to the center line C1. With such a configuration, the electromagnetic wave transmitting heater 52 of the present embodiment can reduce the length of each heater wire 521 as compared to the case where the plurality of heater wires 521 is angled with respect to the center line C1. As a result, the electromagnetic wave transmitting heater 52 of the present embodiment can suppress an increase in the electrical resistance of each heater wire 521 and can suppress an increase in the cross section of each heater wire 521. Thus, according to the electromagnetic wave transmitting heater 52 of the present embodiment, the electromagnetic wave transmitting cover 1 can have an improved designability.

In addition, in the electromagnetic wave transmitting heater 52 of the present embodiment, the distance d2 between the pair of lateral wires 522 is smaller than the distance d1 between one end and the other end of each of the pair of lateral wires 522. With such a configuration, the electromagnetic wave transmitting heater 52 of the present embodiment can reduce the length of each heater wire 521 as compared to the case where the distance d2 between the pair of lateral wires is larger than the distance d1 between one end and the other end of each of the pair of lateral wires 522. As a result, the electromagnetic wave transmitting heater 52 of the present embodiment can suppress an increase in the electrical resistance of each heater wire 521 and can suppress an increase in the cross section of each heater wire 521. Thus, according to the electromagnetic wave transmitting heater 52 of the present embodiment, the electromagnetic wave transmitting cover 1 can have an improved designability.

In addition, in the electromagnetic wave transmitting heater 52 of the present embodiment, the pair of lateral wires 522 has an outwardly projecting curved shape with a vertex that is the intersection with the center line C1. With such a configuration, the electromagnetic wave transmitting heater 52 of the present embodiment has a shape corresponding to the shape of the emblem E, such as an oval, elliptic, or circular shape, for example, and thus can cover a wider area of the surface of the emblem E and efficiently melt snow and ice adhering to the surface of the emblem E.

In addition, L2/L1, that is, a ratio of the length L2 of the lateral wire 522 from the center line C1 to the coupling point P1 to the length L1 of the lateral wire 522 from the center line C1 to one end of the lateral wire 522, is expressed as X. Meanwhile, S2/S1, that is, a ratio of the cross section S2 of the lateral wire 522 to the cross section S1 of the heater wire 521, is expressed as Y. In this case, the electromagnetic wave transmitting heater 52 of the present embodiment satisfies the following expression (1):

(X−0.28)²/0.28²+(Y−11.6)²/3.4²≤1 (1).

With such a configuration, in the electromagnetic wave transmitting heater 52 of the present embodiment, X that expresses L2/L1, that is, a ratio of the length L2 of the lateral wire 522 from the center line C1 to the length L1 of the lateral wire 522 from the center line C1, and Y that expresses S2/S1, that is, a ratio of the cross section S2 of the lateral wire 522 to the cross section S1 of the heater wire 521, are included in the oval area expressed by ΔQ≤1 in FIG. 5. That is, as illustrated in FIG. 4, the difference ΔQ in heating amount between the heater wire 521 having a largest heating amount and the heater wire 521 having a smallest heating amount can be smaller than or equal to 1, and the heating amount of the heater wire 521 having a largest heating amount can be smaller than or equal to double the heating amount of the heater wire 521 having a smallest heating amount.

As a result, the electromagnetic wave transmitting heater 52 can maintain the temperature of the surface of the electromagnetic wave transmitting cover 1, that is, the surface of the transparent film heater 5, within the range of 0° C. to 40° C. inclusive, which is suitable for melting snow and ice and will not adversely affect the resin forming the electromagnetic wave transmitting cover 1 and the transparent film heater 5. Thus, according to the electromagnetic wave transmitting heater 52 of the present embodiment, it is possible to increase the heating properties of the electromagnetic wave transmitting heater 52 corresponding to the shape of the electromagnetic wave transmitting cover 1 that is used as the emblem E.

In addition, in the electromagnetic wave transmitting heater 52 of the present embodiment, among the plurality of heater wires 521, the heating amount of the heater wire 521 having a largest heating amount is smaller than or equal to double the heating amount of the heater wire 521 having a smallest heating amount. With such a configuration, the electromagnetic wave transmitting heater 52 of the present embodiment can maintain the temperature of the surface of the electromagnetic wave transmitting cover 1, that is, the surface of the transparent film heater 5, within the range of 0° C. to 40° C. inclusive, which is suitable for melting snow and ice and will not adversely affect the resin forming the electromagnetic wave transmitting cover 1 and the transparent film heater 5.

As described above, according to the present embodiment, it is possible to provide the electromagnetic wave transmitting heater 52, the transparent film heater 5, and the electromagnetic wave transmitting cover 1 that has excellent heating properties and is capable of suppressing an increase in the cross section of the heater wire 521. It should be noted that the electromagnetic wave transmitting heater, the transparent film heater, and the electromagnetic wave transmitting cover according to the present disclosure are not limited to the aforementioned embodiment. Hereinafter, a modification of the electromagnetic wave transmitting heater 52 according to the aforementioned embodiment will be described.

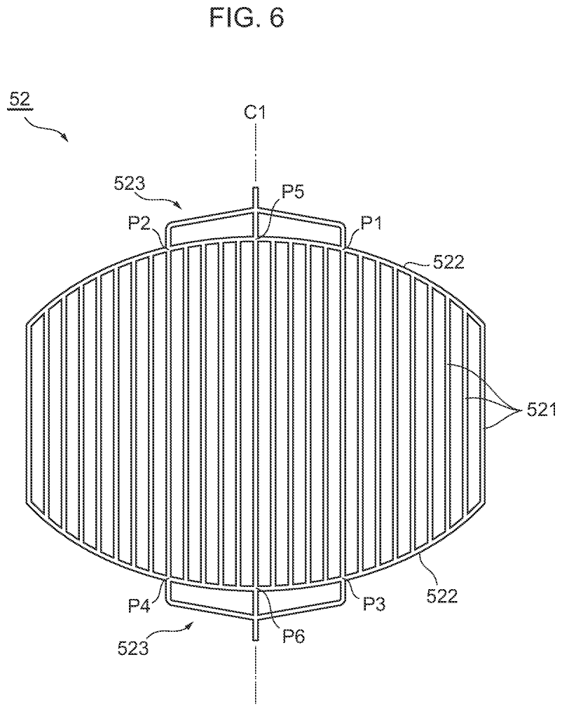

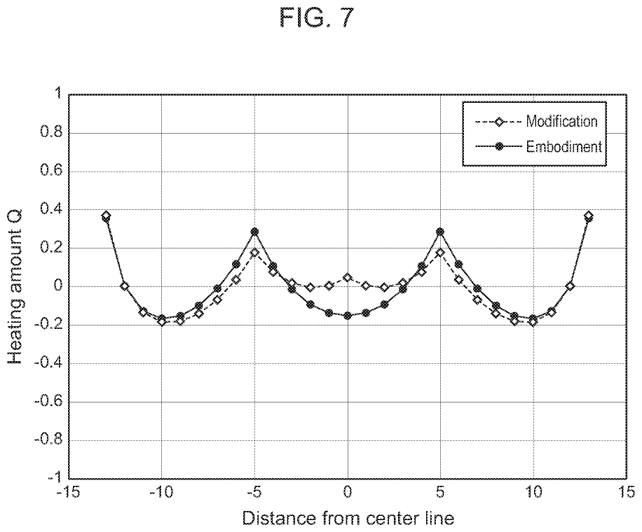

FIG. 6 is a plan view of a modification of the electromagnetic wave transmitting heater 52 of FIG. 3. FIG. 7 is a graph showing the heating amount of each heater wire 521 of the electromagnetic wave transmitting heater 52 of the aforementioned embodiment illustrated in FIG. 3 and the heating amount of each heater wire 521 of the electromagnetic wave transmitting heater 52 of the modification illustrated in FIG. 6.

In the electromagnetic wave transmitting heater 52 of this modification illustrated in FIG. 6, one of the coupling wires 523 is coupled to one of the lateral wires 522 and the other one of the coupling wires 523 is coupled to the other one of the lateral wires 522 respectively at coupling points P5, P6 on the center line C1, in addition to the coupling points P1, P2 and the coupling points P3, P4. As a result, as illustrated in FIG. 7, the electromagnetic wave transmitting heater 52 of this modification can increase the heating amount Q of the heater wire 521 on the center line C1, reduce the heating amounts of the fifth heater wires 521 as counted from the heater wire 521 on the center line C1 to the right and to the left, and obtain more uniform heating properties as compared to the electromagnetic wave transmitting heater 52 of the aforementioned embodiment.

It should be noted that in the electromagnetic wave transmitting heater 52 of the embodiment illustrated in FIG. 7, S1:S2, that is, a ratio between the cross section S1 of the heater wire 521 and the cross section S2 of the lateral wire 522, is 1:9, and L1/L2, that is a ratio of the length L1 of the lateral wire 522 from the center line C1 to the coupling point P1 to the length L2 of the lateral wire 522 from the center line C1 to the end of the lateral wire 522, is 0.31. In the electromagnetic wave transmitting heater 52 of the modification illustrated in FIG. 7, S1:S2, that is, a ratio between the cross section S1 of the heater wire 521 and the cross section S2 of the lateral wire 522, is 1:12, and L1/L2, that is, a ratio of the length L1 of the lateral wire 522 from the center line C1 to the coupling point P1 to the length L2 of the lateral wire 522 from the center line C1 to the end of the lateral wire 522, is 0.31.

As described above, in the electromagnetic wave transmitting heater 52, the number of branches of the coupling wires 523, the number of coupling points P1 to P6 for the lateral wires 522, the ratio between the length L1 and the length L2 of the lateral wire 522, and the like may be changed appropriately. Accordingly, the ratio between the cross section S1 of the heater wire 521 and the cross section S2 of the lateral wire 522 may be changed appropriately.

Although the embodiments of the electromagnetic wave transmitting heater according to the present disclosure have been described in detail above with reference to the drawings, specific structures are not limited thereto, and any design changes that fall within the spirit and scope of the present invention are encompassed by the scope of the present invention.

### DESCRIPTION OF SYMBOLS

2 Electromagnetic wave transmitting heater
521 Heater wire
522 Lateral wire
523 Coupling wire
C1 Center line
d1 Distance
d2 Distance
L1 Length
L2 Length
P1 Coupling point
P2 Coupling point
P3 Coupling point
P4 Coupling point
P5 Coupling point
P6 Coupling point
S1 Cross section
S2 Cross section

What is claimed is:

1. An electromagnetic wave transmitting heater, comprising:
a plurality of heater wires disposed at intervals to allow transmission of electromagnetic waves;
a pair of lateral wires, one of the pair of lateral wires being coupled to one end of each of the heater wires, another one of the pair of lateral wires being coupled to another end of each of the heater wires; and
a pair of coupling wires, one of the pair of coupling wires being coupled to one of the pair of lateral wires, another one of the pair of coupling wires being coupled to another one of the pair of lateral wires,
wherein the lateral wires each have a cross section larger than a cross section of each of the heater wires.

2. The electromagnetic wave transmitting heater according to claim 1,
wherein:
the pair of lateral wires is axisymmetric with respect to a center line intersecting the pair of lateral wires,
as a distance from the center line along the lateral wire increases, a distance between the pair of lateral wires decreases and a length of the heater wire decreases, and
one of the coupling wires is coupled to one of the lateral wires at a plurality of coupling points that is axisymmetric with respect to the center line and another one of the coupling wires is coupled to another one of the lateral wires at a plurality of coupling points that is axisymmetric with respect to the center line.

3. The electromagnetic wave transmitting heater according to claim 2, wherein the plurality of heater wires is parallel to the center line.

4. The electromagnetic wave transmitting heater according to claim 3, wherein a distance between the pair of lateral wires is smaller than a distance between one end and another end of each of the pair of lateral wires.

5. The electromagnetic wave transmitting heater according to claim 4, wherein the pair of lateral wires has an outwardly projecting curved shape with a vertex, the vertex being an intersection with the center line.

6. The electromagnetic wave transmitting heater according to claim 5, wherein when X is a ratio of a length of the lateral wire from the center line to the coupling point to a length of the lateral wire from the center line to one end of the lateral wire, and Y is a ratio of a cross section of the lateral wire to a cross section of the heater wire, the electromagnetic wave transmitting heater satisfies the following expression (1):
(X−0.28)²/0.28²+(Y−11.6)²/3.4²≤1 (1).

7. The electromagnetic wave transmitting heater according to claim 2, wherein among the plurality of heater wires, a heating amount of the heater wire having a largest heating amount is smaller than or equal to double a heating amount of the heater wire having a smallest heating amount.
